(19) United States
(12) Patent Application Publication
(10) Pub. No.: US 2026/0208779 A1
(43) Pub. Date: Jul. 23, 2026

(54) FOLDABLE WAGON

(71) Applicant: Ningbo Dongrun Mining Co., Ltd., Ningbo City Zhejiang Province (CN)

(72) Inventor: Libo Song, Ningbo City Zhejiang Province (CN)

(21) Appl. No.: 19/571,424

(22) Filed: Mar. 18, 2026

(30) Foreign Application Priority Data
Feb. 12, 2026 (CN) 202620211916.X

(51) Int. Cl. B62B 3/02; B62B 5/06

(52) U.S. Cl. CPC B62B 3/022; B62B 5/065

(57) ABSTRACT

A foldable wagon, comprising: a first frame, a second frame, a foldable side guard, a third frame, and an operating rod; wherein, during a process of transitioning from a deployed state to a folded state, the first frame translationally approaches the second frame, the foldable side guard transitions from an extended state to a retracted state, the third frame rotatably folds relative to the first frame, and the operating rod rotatably folds relative to the third frame; the foldable wagon effectively reduces in volume after being folded, and is suitable for outdoor travel use.

### TECHNICAL FIELD

The present invention relates to the technical field of wagons, and specifically to a foldable wagon.

### BACKGROUND

As a common tool for scenarios such as home moving, outdoor camping material transfer, and supermarket shopping loading, the core competitiveness of a foldable wagon lies in minimizing storage volume through structural folding while ensuring sufficient load-bearing capacity and use stability after deployment. An ideal foldable wagon needs to meet the core requirements of “no frame collision interference, synchronous linkage of various components, convenient folding/deployment operations, and being compact and non-redundant after storage.” It must not only facilitate a quick state switching by a single person but also ensure ease of carrying and storage after folding, as well as stable load-bearing of items after deployment to adapt to the needs of diverse usage scenarios.

Existing foldable wagons have obvious defects in the synergistic folding structural design of the frame, side guards, and operating rods, making it difficult to balance folding compactness and operational convenience. Specific problems are as follows:

Firstly, most front frames and rear frames of existing wagons use a single hinge connection, which can only achieve simple relative rotation during folding and lacks precise guiding and limiting structures, leading to problems such as frame offset and collision interference. After folding, the front and rear frames cannot closely abut each other, and a large gap still exists, resulting in the storage volume being unable to be effectively reduced. This occupies more storage space in car trunks and storage rooms, and the wagon is prone to rubbing against other items during carrying, showing weak capability in adapting to outdoor travel and narrow spaces.

Secondly, some foldable wagons are not provided with side guards, which causes items to easily slide off from the sides during deployment and use. Although some wagons have additional side guards, the side guards are of fixed structures or need to be folded separately, failing to synchronously link with the folding actions of the front and rear frames. During deployment, additional manual installation or deployment of the side guards is required, and during folding, the side guards need to be separately disassembled or retracted first, resulting in cumbersome operation steps. Moreover, separately folded side guards are prone to positioning deviations and may protrude to the outer side of the frame after folding, further increasing the storage volume and potentially interfering with other components.

Thirdly, most operating rods of existing wagons are fixedly connected to the frame or can only rotate at a small angle, failing to form a synergistic linkage mechanism with the frame folding. During folding, the operating rod either cannot be folded and protrudes from the frame as a whole, significantly increasing the storage volume, or requires multiple steps to achieve folding, and cannot closely fit the frame after folding, leading to shaking and loosening. At the same time, a transition connection structure is lacking between the operating rod and the frame. When the operating rod is directly pivotally connected to a main frame, stress concentration during folding easily causes wear and fracture of the first connection part, affecting the service life.

Fourthly, the frame folding, side guard retraction, and operating rod folding of existing wagons need to be completed independently in steps, lacking an integrated linkage design, and requiring repeated adjustment of positions of various components when switching states, leading to a complex operation process. Especially in scenarios such as outdoor camping and supermarket shopping where urgent use or storage is required, it is difficult for a single person to quickly complete deployment or folding, which seriously affects use efficiency. Furthermore, some structures need additional fixing after folding; otherwise, they are prone to spontaneous deployment, posing a safety hazard.

### SUMMARY

To overcome the problem that the volume of a foldable wagon is still large after folding in the prior art, the present invention provides a foldable wagon.

In order to achieve the above objective, the present invention adopts the following technical solution: a foldable wagon, comprising:
a first frame disposed at a front side of the foldable wagon;
a second frame disposed at a rear side of the foldable wagon;
a foldable side guard disposed at a left side or a right side of the foldable wagon; two ends thereof being respectively pivotally connected to the first frame and the second frame;
a third frame pivotally disposed at the front side of the foldable wagon; and
an operating rod, a lower end thereof being pivotally connected to the third frame;
wherein the foldable wagon has a deployed state and a folded state, and during a process of transitioning from the deployed state to the folded state, the first frame translationally approaches the second frame to realize that the first frame and the second frame closely abut each other in the folded state, the foldable side guard transitions from an extended state to a retracted state, the third frame rotatably folds relative to the first frame to cause the third frame to closely abut the first frame, and the operating rod rotatably folds relative to the third frame.

Further, the foldable wagon further comprises a foldable bottom frame disposed at a bottom part of the foldable wagon and having two ends thereof respectively pivotally connected to the first frame and the second frame, the foldable bottom frame comprising a first bottom frame and a second bottom frame pivotally connected to each other; when the foldable wagon is folded, the first bottom frame rotatably folds relative to the second bottom frame.

Further, the foldable side guard is pivotally connected to an outer side of the first frame and the second frame, and the foldable bottom frame is pivotally connected to an inner side of the first frame and the second frame.

The advantageous effects of the present invention are as follows:

During the folding process, the first frame translationally approaches the second frame to realize that the first frame and the second frame closely abut each other, replacing the existing frame structure that uses a single hinge connection and lacks guiding and limiting functions. This fundamentally solves the problems of offset and collision interference during frame folding. Meanwhile, the frame fits tightly with no redundant gap, which, in coordination with the linkage folding of other components, significantly reduces the overall volume of the wagon after folding. The occupancy of storage space in car trunks and storage rooms is significantly reduced, and the wagon is less likely to rub against other items during carrying, meeting the core requirements of outdoor travel and storage in narrow spaces.

The two ends of the foldable side guard are pivotally connected to the first frame and the second frame, and can synchronously complete switching between a retracted state and an extended state following the folding/deployment action of the frame without requiring separate disassembly, installation, or folding operations. This completely solves the problems of fixed existing side guards, cumbersome separate operations, and protruding redundancy after folding. In the deployed state, the side guard can effectively prevent items from sliding off from the side of the wagon after extending, ensuring loading safety. In the folded state, the side guard synchronously retracts to fit the frame without adding additional storage volume or interfering with other components.

The third frame is pivotally connected to the front side of the wagon, and the lower end of the operating rod is pivotally connected to the third frame. During folding, the third frame can rotate relative to the first frame and closely abut the first frame, and the operating rod synchronously rotatably folds relative to the third frame, forming a “third frame-operating rod” integrated linkage folding mechanism. This not only solves the problems of cumbersome folding steps of existing operating rods, inability to fit the frame after folding, and protruding redundancy, but also disperses stress during folding and pushing through the third frame acting as a transition connection, thereby avoiding wear and fracture of the first connection part caused by the operating rod being directly pivotally connected to the main frame, and extending the service life of the wagon.

The frame, the side guard, the third frame, and the operating rod form a full-process linkage mechanism. When transitioning from the deployed state to the folded state, various components move synchronously without needing separate independent operations. A single person can quickly complete state switching, completely solving the drawbacks of cumbersome operation steps and difficulty in quick operation by a single person in existing wagons. It is especially suitable for scenarios requiring urgent deployment or storage, such as outdoor camping material transfer and supermarket shopping loading, significantly improving use efficiency. Meanwhile, no additional fixing is required after folding, avoiding the safety hazard of spontaneous deployment.

The pivotal connection and linkage design of various components form a stable overall support structure after the wagon is deployed. The first frame and the second frame cooperate closely to provide a reliable load-bearing foundation. The foldable side guard has accurate positioning and sufficient rigidity after extending, which can effectively resist squeezing of items and avoid inward tilting. The pivotal connection between the third frame and the operating rod is tight, with no shaking and loosening during pushing, ensuring that the wagon can stably carry items after being deployed and is not easily deformed when subjected to slight collision, taking into account both use safety and load-bearing reliability.

### BRIEF DESCRIPTION OF THE DRAWINGS

FIG. 1 is a schematic diagram of a usage state of a foldable wagon in an embodiment of the present invention.

FIG. 2 is an enlarged view of part A in FIG. 1.

FIG. 3 is an enlarged view of part B in FIG. 1.

FIG. 4 is an enlarged view of part C in FIG. 1.

FIG. 5 is a schematic diagram of a storage state in the embodiment shown in FIG. 1.

FIG. 6 is a schematic diagram of a positioning member in the embodiment shown in FIG. 1.

FIG. 7 is a schematic diagram of a third fixing member in the embodiment shown in FIG. 1.

FIG. 8 is a schematic diagram showing the cooperation between the third fixing member and the positioning member in the embodiment shown in FIG. 1.

Reference numerals in the drawings are as follows: 101, first frame; 102, second frame; 103, foldable side guard; 104, foldable bottom frame; 1041, first bottom frame; 1042, second bottom frame; 105, bottom frame connector; 106, second link; 107, third link; 108, fourth link; 109, first link; 110, operating rod; 111, sleeve; 112, extension rod; 113, pull ring; 114, positioning member; 1141, positioning groove; 115, wheel; 116, connecting base; 117, connecting sleeve; 118, support part; 119, third frame; 120, mounting frame; 121, fourth fixing member; 122, first connecting portion; 123, first fixing member; 124, second fixing member; 125, insert block; 1251, through slot; 126, third fixing member; 127, insert rod; 1271, protuberance; 128, rod body.

### DETAILED DESCRIPTION OF THE DISCLOSURE

Embodiments of the present disclosure will be described in more detail below with reference to the accompanying drawings. While certain embodiments of the present disclosure are shown in the drawings, it should be understood that the present disclosure can be implemented in various forms and should not be construed as being limited to the embodiments set forth herein. On the contrary, these embodiments are provided for a more thorough and complete understanding of the present disclosure. It should be understood that the drawings and embodiments of the present disclosure are only for exemplary purposes and are not intended to limit the scope of protection of the present disclosure. Additionally, it should be noted that for convenience of description, only parts related to the relevant invention are shown in the drawings. In the case of no conflict, the embodiments in the present disclosure and the features in the embodiments can be combined with each other.

The present disclosure will be described in detail below with reference to the drawings and in combination with the embodiments.

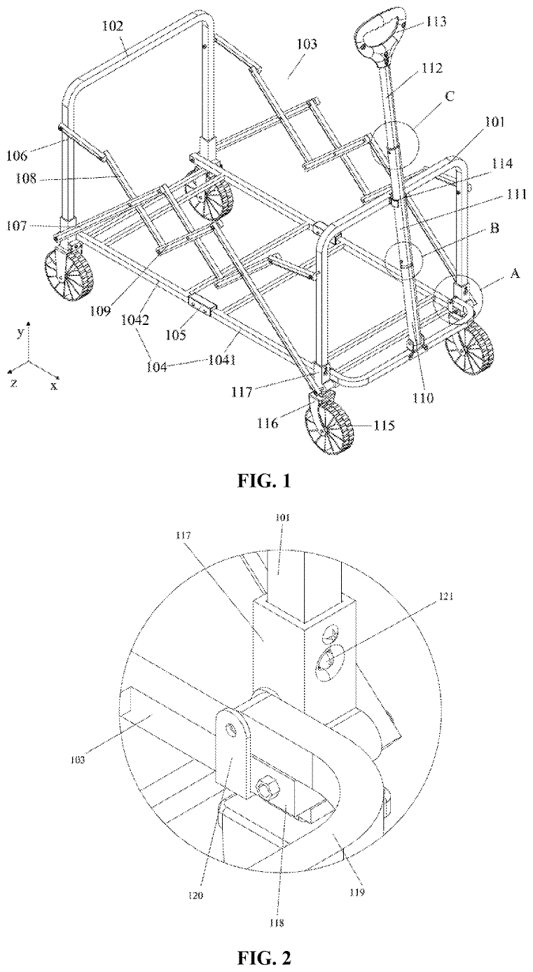

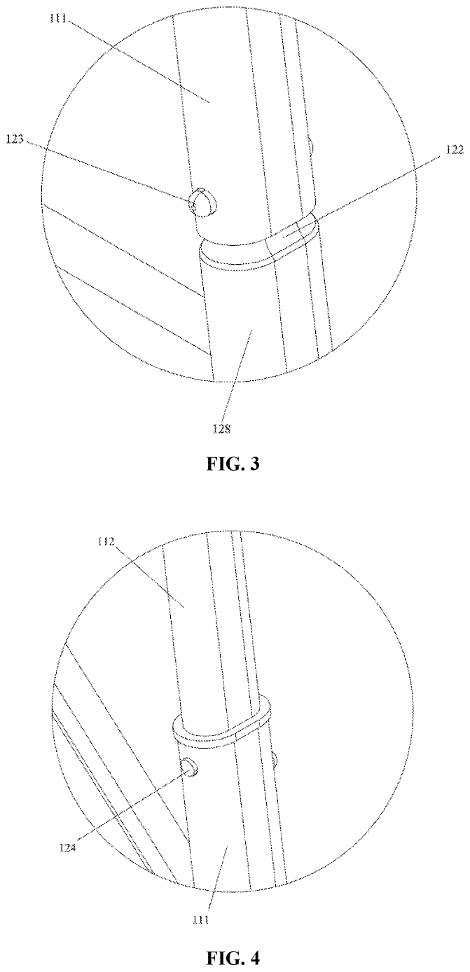

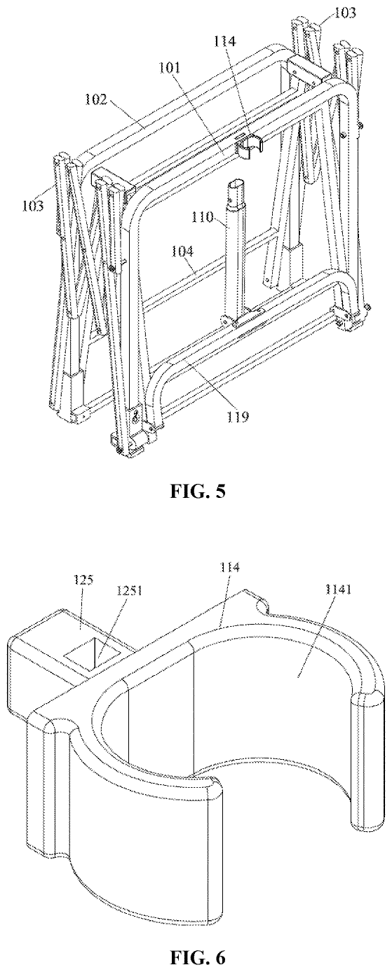

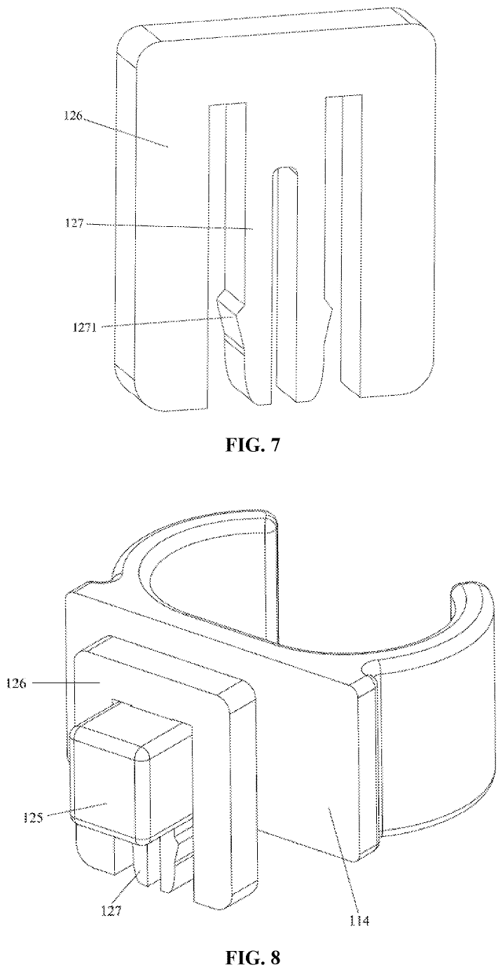

As shown in FIGS. 1 to 8, a foldable wagon comprises a first frame 101, a second frame 102, a third frame 119, a foldable side guard 103, an operating rod 110, and a foldable bottom frame 104.

The first frame 101 is disposed at a front side of the foldable wagon; the second frame 102 is disposed at a rear side of the foldable wagon; the foldable side guard 103 is disposed at a left side and a right side of the foldable wagon, and two ends thereof are respectively pivoted to the first frame 101 and the second frame 102; the third frame 119 is pivotally disposed at the front side of the foldable wagon; and a lower end of the operating rod 110 is pivotally connected to the third frame 119; wherein the foldable wagon has a deployed state and a folded state, and during a process of transitioning from the deployed state to the folded state, the first frame 101 translationally approaches the second frame 102 to realize being arranged to closely abut each other during folding, the foldable side guard 103 transitions from an extended state to a retracted state, the third frame 119 rotatably folds relative to the first frame 101 to cause the third frame 119 to closely abut the first frame 101, and the operating rod 110 rotatably folds relative to the third frame 119. Through the transition of the foldable wagon between the deployed state and the folded state, use requirements in different scenarios can be flexibly met. In the deployed state, the first frame 101 and the second frame 102 form a stable load-bearing platform, the foldable bottom frame 104 is deployed to provide reliable bottom support, the foldable side guard 103 effectively prevents side sliding of items after extending, and the third frame 119 and the operating rod 110 are deployed to positions convenient for pushing, so that the overall structure is stable and work such as material transfer can be efficiently completed; while in the folded state, the first frame 101 and the second frame 102 closely abut each other, the foldable side guard 103 retracts to fit the frame, the third frame 119 closely abuts the first frame 101 after rotating, and the operating rod 110 is also synchronously folded and fits the third frame 119, such that various components cooperate with each other to significantly reduce the overall volume of the wagon, which is convenient for storage and carrying.

The foldable bottom frame 104 is disposed at a bottom part of the foldable wagon and two ends thereof are respectively pivoted to the first frame 101 and the second frame 102, and the foldable bottom frame 104 comprises a first bottom frame 1041 and a second bottom frame 1042 pivotally connected to each other; when the foldable wagon is folded, the first bottom frame 1041 rotatably folds relative to the second bottom frame 1042. Specifically, the first bottom frame 1041 and the second bottom frame 1042 are rotatably connected through a pivot shaft at a middle part. When the first frame 101 and the second frame 102 approach each other during the folding process, the first bottom frame 1041 and the second bottom frame 1042, driven by the first frame 101 and the second frame 102, rotate toward each other with the pivot shaft as a center, causing the bottom frame that was originally horizontally deployed to fold upwardly, thereby further reducing the overall height and the floor area after folding. Such a design ensures that the bottom frame can coordinate with the folding action of the frame, avoiding jamming or interference between the bottom frame and other components during the folding process, and also ensuring that in the deployed state, the bottom frame can provide sufficient support area and structural strength to bear the weight of various items.

Further, the foldable bottom frame 104 further comprises a bottom frame connector 105, the bottom frame connector 105 is a U-shaped structure, and the first bottom frame 1041 and the second bottom frame 1042 are respectively provided with second connecting portions, the second connecting portions being a square tube structure, the second connecting portions being pivotally connected inside a groove body of the bottom frame connector 105, hinge holes being correspondingly opened on two side walls of the bottom frame connector 105, and pin shafts cooperating with the hinge holes being provided at ends of the second connecting portions, so as to achieve the pivotal connection of the first bottom frame 1041 and the second bottom frame 1042 through the rotational cooperation between the pin shafts and the hinge holes. Such a design of the bottom frame connector 105 of the U-shaped structure can stably wrap the second connecting portions inside the groove body, which not only enhances the firmness of the connection, but also provides a good guiding function during relative rotation of the frames, ensuring smoothness of the folding and deployment process. Meanwhile, the second connecting portions of the square tube structure have high structural strength, and can effectively transmit a support force of the frames and a rotational torque during folding, avoiding deformation or damage during long-term use, thereby extending the service life of the entire foldable bottom frame 104 and even the wagon. When items are placed on the bottom frame, the first bottom frame 1041 and the second bottom frame 1042 bear gravity and generate a bending tendency. At this time, side walls of the second connecting portions abut against an inner wall of the groove body of the bottom frame connector 105, and the bottom frame connector 105 maintains the first bottom frame 1041 and the second bottom frame 1042 in a state tending toward a straight line, forming a rigid support for the bottom frame, preventing the bottom frame from bending and deforming due to excessive force, and simultaneously causing the first frame 101 and the second frame 102 to be in an open state, ensuring structural stability and reliability of the bottom frame in a load-bearing state.

Applying a force acting along a vertical upward direction to the bottom frame connector 105, the bottom frame connector 105 drives a first support and a second support at two ends thereof to flip with connection points to the bottom frame connector 105 as axial centers. At this time, free ends of the first support and the second support approach each other, thereby respectively driving the first frame 101 and the second frame 102 rotatably connected thereto to fold toward an inner side of the wagon, so as to achieve longitudinal contraction of the frames; conversely, when the bottom frame connector 105 moves along a vertical downward direction, the first support and the second support flip in opposite directions and the free ends thereof move away from each other, thereby pushing the first frame 101 and the second frame 102 to be deployed toward two sides until reaching stable positions in the usage state, so as to provide a sufficient platform area for bearing items. Such a structure that drives the supports to flip through the bottom frame connector 105 to drive the frames to open and close makes the deployment and storage operations of the frames more labor-saving and has good synchronicity, effectively avoiding the problem of jamming caused by inconsistent movement of the two sides of the frames.

In another embodiment, the setting of the foldable bottom frame 104 may be omitted. After the first frame 101 and the second frame 102 are opened, a rod or a plate for support is placed between the first frame 101 and the second frame 102 to serve as a bottom surface of the foldable wagon. For example, rigid plate materials such as wooden boards or metal plates can be directly placed, or flexible load-bearing members such as foldable fabrics or mesh bags can be used to achieve construction of the bottom surface through a simple placing or tying manner, so as to meet temporary or lightweight usage needs. Such a design provides more flexibility for users. When users have low requirements for load-bearing capacity or need to further simplify the structure of the wagon, users can choose whether to install the foldable bottom frame 104 according to actual situations, thereby achieving a balance between portability and functionality.

Further, the foldable side guard 103 is pivotally connected to an outer side of the first frame 101 and the second frame 102, and the foldable bottom frame 104 is pivotally connected to an inner side of the first frame 101 and the second frame 102. Such a layout design enables the foldable side guard 103 to form effective protection for loaded items from the outer side of the frames during deployment, avoiding side sliding of items, while the foldable bottom frame 104 provides bottom support from the inner side of the frames, and both perform their respective functions without interfering with each other. During the folding process, the foldable side guard 103 located at the outer side and the foldable bottom frame 104 located at the inner side can respectively retract or fold toward a main frame body direction, which further ensures tight fitting of various components after folding, avoiding the problem of mutual obstruction between components or excessive volume after folding caused by unreasonable layout.

The third frame 119 is pivotally connected to the first bottom frame 1041 or the first frame 101. In the present embodiment, the first bottom frame 1041 is provided with a mounting frame 120, the third frame 119 is rotatably connected to the mounting frame 120, and one end of the first bottom frame 1041 passes out from the mounting frame 120 to form a support part 118 corresponding to the third frame 119. When the third frame 119 is flipped to a usage position, the support part 118 can provide stable support for the third frame 119, preventing the third frame 119 from shaking or rotating during pushing of the wagon, and ensuring operational stability of the operating rod 110. Specifically, the mounting frame 120 is fixedly disposed at a position on one end of the first bottom frame 1041 close to a middle part, and the third frame 119 is rotatably connected to the mounting frame 120 through a rotating shaft, such that the third frame 119 can flip around the rotating shaft. Such a support structure is simple and practical in design, and stable positioning of the third frame 119 can be realized without additional locking members, which not only simplifies operation steps but also improves reliability during use of the wagon.

A wheel 115 assembly is mounted on the first frame 101 and the second frame 102. The wheel 115 assembly comprises a connecting base 116, a connecting rod, and a wheel 115. The wheel 115 is disposed at a bottom part of the connecting base 116, the connecting rod is disposed at a top part of the connecting base 116, and the wheel 115 assembly is connected to the first frame 101 or the second frame 102 through the connecting rod. Specifically, a connecting sleeve 117 is sleeved on a bottom part of the first frame 101 and the second frame 102, and the connecting rod is inserted within the connecting sleeve 117; a fourth fixing member 121 is provided on the connecting rod, the fourth fixing member 121 being an elastic locking pin, and an engagement hole corresponding to the fourth fixing member 121 is provided on the connecting sleeve 117. When the wheel 115 was installed, the connecting rod was inserted into the connecting sleeve 117 to a preset depth. At this time, the elastic locking pin popped out and locked into the engagement hole of the connecting sleeve 117 under an action of an elastic force of the elastic locking pin, realizing quick fixing of the wheel 115 and the frame; when the wheel 115 was disassembled, the elastic locking pin was pressed to cause the elastic locking pin to retract into the connecting rod, so that the connecting rod was extracted from the connecting sleeve 117, which is convenient for disassembly, assembly, and replacement of the wheel 115.

When the foldable wagon is in a storage state, the wheel 115 can be disassembled from the first frame 101 and the second frame 102 to further reduce space occupancy of the wagon in a height direction and a transverse direction, realizing ultimate compression of the foldable wagon as a whole. Such a design in which the wheel 115 is detachable enables a volume of the foldable wagon in the storage state to be further optimized, making the foldable wagon more convenient to be stored in narrow spaces, such as a car trunk, a corner of a storage room, etc., which greatly improves space adaptability and portability of the wagon.

Further, the operating rod 110 is a telescopic rod. The operating rod 110 comprises a rod body 128, a sleeve 111, and an extension rod 112. The sleeve 111 is connected to one end of the rod body 128, the extension rod 112 is located within the sleeve 111 and is capable of moving along an inner wall of the sleeve 111, and a second fixing member 124 corresponding to the sleeve 111 is provided on the extension rod 112. A first connecting portion 122 is provided on the rod body 128, the sleeve 111 is sleeved on the first connecting portion 122, a first fixing member 123 is provided on the first connecting portion 122, and fixing holes corresponding to the first fixing member 123 and the second fixing member 124 are provided on a side wall of the sleeve 111.

The first fixing member 123 is a V-shaped spring disposed on the first connecting portion 122, and the second fixing member 124 is a V-shaped spring disposed on the extension rod 112. When the sleeve 111 was sleeved on the first connecting portion 122, a bead portion of the V-shaped spring on the first connecting portion 122 was snapped into a fixing hole of the side wall of the sleeve 111, realizing fixed connection between the sleeve 111 and the rod body 128; when a length of the operating rod 110 needed to be adjusted, the V-shaped spring on the extension rod 112 was pressed to cause the V-shaped spring to retract, and then the extension rod 112 was pulled to slide along the inner wall of the sleeve 111 to a required length. At this time, the bead portion of the V-shaped spring on the extension rod 112 was snapped into a fixing hole at a corresponding position of the side wall of the sleeve 111, completing fixing of the length of the operating rod 110. Such a telescopic design enables the operating rod 110 to accommodate users of different heights, improving pushing comfort, and simultaneously, the extension rod 112 can be retracted into the sleeve 111 during folding and storage to further shorten the length of the operating rod 110 and reduce an overall volume after folding. A pull ring 113 is further provided at a top end of the extension rod 112, and the pull ring 113 is rotatably connected to the extension rod 112, which is convenient for a lifting operation when folding or deploying the wagon, and is also convenient for handling the wagon in the storage state.

When the foldable wagon is in the storage state, the V-shaped spring as the first fixing member 123 can be pressed to cause the V-shaped spring to compress a spring and retract into the first connecting portion 122, and then the sleeve 111 is disassembled from the first connecting portion 122, further reducing an overall height and the volume of the foldable wagon during storage, realizing extreme space saving. The sleeve 111 and the extension rod 112 after disassembly can be stored separately or bundled with a main frame body of the wagon, avoiding parts scattering and losing, and improving tidiness and portability of storage.

A positioning member 114 is provided on the first frame 101, and a positioning groove 1141 corresponding to the sleeve 111 is provided on the positioning member 114; an insert block 125 is provided on the positioning member 114, an insertion slot is provided on the first frame 101, and a third fixing member 126 is inserted within the insertion slot to fix the insert block 125 within the insertion slot. Specifically, two insert rods 127 are provided on the third fixing member 126, a gap is left between the two insert rods 127, the insert rods 127 are made of plastic, a protuberance 1271 is provided on a side wall of each of the insert rods 127, and a through slot 1251 corresponding to the insert rods 127 is provided on the insert block 125. The positioning member 114 is mounted through cooperation between the insert block 125 and the insertion slot on the first frame 101. After the insert block 125 was inserted into the insertion slot, the two insert rods 127 of the third fixing member 126 were inserted into the through slot 1251 of the insert block 125. Since the insert rods 127 are of a plastic material and the side walls are provided with the protuberances 1271, the insert rods 127 underwent elastic deformation after being inserted into the through slot 1251, and the protuberances 1271 passed through the through slot 1251 along with the insert rods 127 and then abutted against a bottom of the through slot 1251, thereby fixing the insert block 125 stably within the insertion slot, ensuring that the positioning member 114 will not fall off during use. Such a design of the positioning member 114 being detachable is not only convenient for fixing the sleeve 111 when needed, but also convenient for disassembling the sleeve 111 when not needed, avoiding interference with other functions of the wagon, and further improving flexibility and practicality of a wagon structure.

When the foldable wagon is in a usage state, the sleeve 111 can abut inside the positioning groove 1141. By utilizing a shape of the positioning groove 1141 to adapt to a peripheral contour of the sleeve 111, lateral limit is formed for the sleeve 111, preventing the operating rod 110 from undergoing lateral offset or rotation due to force during pushing, further enhancing operational stability of the operating rod 110.

The foldable side guard 103 comprises at least one set of scissor structure, the scissor structure comprises two first links 109, the two first links 109 are arranged in a crossing manner, and middle parts of the two said first links 109 are rotatably connected at one point. Through such a cross-rotation structure, the foldable side guard 103 can extend accordingly when the frame is deployed to form side shielding for loaded items, and when the frame is folded, the two first links 109 rotatably approach each other to drive the foldable side guard 103 as a whole to retract and fold to fit a side of the frame. When the first frame 101 and the second frame 102 are deployed away from each other, the two crossing first links 109, driven by the frame, rotate toward two sides with a rotational connection point at the middle parts as a center, such that an overall length of the foldable side guard 103 increases until the first frame 101 and the second frame 102 are fully deployed. At this time, a maximum included angle is reached between the two first links 109, and the foldable side guard 103 forms a stable planar or approximately planar structure, effectively blocking items from side sliding. When the wagon needs to be folded, as the first frame 101 and the second frame 102 approach each other, the two first links 109 rotate in opposite directions under an action of a pulling force, a crossing angle is reduced, and the length of the foldable side guard 103 is shortened accordingly, and finally, the foldable side guard 103 is folded and retracted at an outer side of the first frame 101 and the second frame 102 without occupying extra space. Such a scissor structure is not only convenient for folding and deployment operations, but also has good structural stability and load-bearing capacity, and can reliably protect items in the wagon in the deployed state.

The foldable side guard 103 further comprises a second link 106, a third link 107, and a fourth link 108. One end of the second link 106 is pivotally connected to the fourth link 108, and the other end is pivotally connected to a side wall of the first frame 101 or the second frame 102. One end of the third link 107 is pivotally connected to the first link 109, and the other end is pivotally connected to a bottom end of the first frame 101 or the second frame 102, and a middle part of the third link 107 and a middle part of the fourth link 108 are pivotally connected at one point. The other end of the fourth link 108 is pivotally connected to the first link 109. Such a multi-link composite structure design further enhances structural strength and stability of the foldable side guard 103 in the deployed state. When the foldable side guard 103 extends, the second link 106 and the third link 107 have a synergistic effect with the two crossing first links 109 to jointly constitute multiple mutually supporting triangular units, such that the foldable side guard 103 can bear large lateral pressure, effectively preventing the foldable side guard 103 from undergoing deformation when there are many loaded items or when the wagon bumps. During the folding process, as the first frame 101 and the second frame 102 approach each other, the second link 106 and the third link 107 respectively rotate around respective pivot points thereof to drive the crossing angle between the two first links 109 to be reduced, thereby realizing smooth contraction of the foldable side guard 103, ensuring that the foldable side guard 103 can tightly fit the side of the frame without generating redundant protrusion or space occupancy.

What is claimed is:

1. A foldable wagon, comprising:
a first frame disposed at a front side of the foldable wagon;
a second frame disposed at a rear side of the foldable wagon;
a foldable side guard disposed at a left side or a right side of the foldable wagon; two ends thereof being respectively pivotally connected to the first frame and the second frame;
a third frame pivotally disposed at the front side of the foldable wagon; and
an operating rod, a lower end thereof being pivotally connected to the third frame;
wherein the foldable wagon has a deployed state and a folded state, and during a process of transitioning from the deployed state to the folded state, the first frame translationally approaches the second frame, the foldable side guard transitions from an extended state to a retracted state, the third frame rotatably folds relative to the first frame to cause the third frame to closely abut the first frame, and the operating rod rotatably folds relative to the third frame.

2. The foldable wagon according to claim 1, further comprising a foldable bottom frame disposed at a bottom part of the foldable wagon and having two ends thereof respectively pivotally connected to the first frame and the second frame, the foldable bottom frame comprising a first bottom frame and a second bottom frame pivotally connected to each other; when the foldable wagon is folded, the first bottom frame rotatably folds relative to the second bottom frame.

3. The foldable wagon according to claim 2, wherein the foldable side guard is pivotally connected to an outer side of the first frame and the second frame, and the foldable bottom frame is pivotally connected to an inner side of the first frame and the second frame.

4. The foldable wagon according to claim 3, wherein the third frame is pivotally connected to the first bottom frame or the first frame, and the first bottom frame and the second bottom frame form a hinge through a bottom frame connector.

5. The foldable wagon according to claim 1, wherein a wheel assembly is mounted on the first frame and the second frame, the wheel assembly comprising a connecting base, a connecting rod, and a wheel, the wheel being disposed at a bottom of the connecting base, the connecting rod being disposed at a top of the connecting base, and the wheel assembly being connected to the first frame or the second frame through the connecting rod.

6. The foldable wagon according to claim 5, wherein a connecting sleeve is sleeved on a bottom part of the first frame and the second frame, and the connecting rod is inserted within the connecting sleeve; a fourth fixing member is provided on the connecting rod, and an engagement hole corresponding to the fourth fixing member is provided on the connecting sleeve.

7. The foldable wagon according to claim 1, wherein the operating rod is a telescopic rod, the operating rod comprising a rod body, a sleeve, and an extension rod, the sleeve being connected to one end of the rod body, the extension rod being located within the sleeve and being movable along an inner wall of the sleeve, and a second fixing member corresponding to the sleeve being provided on the extension rod.

8. The foldable wagon according to claim 7, wherein a first connecting portion is provided on the rod body, the sleeve is sleeved on the first connecting portion, a first fixing member is provided on the first connecting portion, and a fixing hole corresponding to the first fixing member is provided on a side wall of the sleeve.

9. The foldable wagon according to claim 1, wherein the foldable side guard comprises at least one group of scissor structure, the scissor structure comprising two first links, the two first links being arranged in a crossing manner, and middle parts of the two first links being rotatably connected at one point.

10. The foldable wagon according to claim 9, further comprising a second link, a third link, and a fourth link, one end of the second link being pivotally connected to the fourth link, and another end thereof being pivotally connected to a side wall of the first frame or the second frame, one end of the third link being pivotally connected to the first link, and another end thereof being pivotally connected to a bottom end of the first frame or the second frame, a middle part of the third link and a middle part of the fourth link being pivotally connected at one point, and another end of the fourth link being pivotally connected to the first link.
